(19) United States
(12) Patent Application Publication
(10) Pub. No.: US 2018/0016974 A1
(43) Pub. Date: Jan. 18, 2018

(54) BALL BEARING IN PARTICULAR CONNECTING ROD BALL BEARING AND CONNECTING ROD WITH THE BALL BEARING

(71) Applicant: ECO Holding 1 GmbH, Marktheidenfeld (DE)

(72) Inventors: Dietmar Schulze, Muenzenberg (DE); Dietmar Kaufmann, Tiefenthal (DE)

(21) Appl. No.: 15/681,397

(22) Filed: Aug. 20, 2017

Related U.S. Application Data
(63) Continuation of application No. PCT/EP2016/051397, filed on Jan. 25, 2016.

(30) Foreign Application Priority Data
Mar. 10, 2015 (DE) DE102015103467.0

(51) Int. Cl. F02B 75/04; F16C 7/06; F16C 23/10; F16J 1/22; F16C 11/06; F02D 15/02

(52) U.S. Cl. CPC F02B 75/045; F16J 1/22; F16C 11/0685; F16C 7/06; F16C 23/10; F16C 11/0623; F02D 15/02; F16C 2360/22

(57) ABSTRACT

A ball bearing including a ball head that is arranged at a support rod, wherein the ball head is supported in a ball head receiver of an exterior component, and wherein the ball head is secured at its outer surface by at least one radially inward protruding safety element of the ball head receiver against sliding out of the ball head receiver. The invention also relates to a connecting rod including the ball bearing.

### RELATED APPLICATIONS

This application is a continuation of International Patent Application PCT/EP2016/051397 filed on Jan. 25, 2016 claiming priority from German Patent Application DE 10 2015 103 467.0 filed on Mar. 10, 2015, both of which are incorporated in their entirety by this reference.

### FIELD OF THE INVENTION

The invention relates to a ball bearing and to a connecting rod with the ball bearing.

### BACKGROUND OF THE INVENTION

In internal combustion engines a high compression ratio has a positive effect upon efficiency of the internal combustion engine. Compression ratio is typically defined as a ratio of an entire cylinder volume before compression and a remaining cylinder volume after the compression. In internal combustion engines with external ignition, in particular in gasoline engines which have a fixed compression ratio, the compression ratio may only be selected high enough so that so called knocking of the internal combustion engine under full load operations is prevented. However, for partial load operations of the internal combustion engine, thus at a lower cylinder filling volume which is much more prevalent the compression ratio can be selected with higher values without the knocking occurring. The important partial load range of the internal combustion engine can be improved when the compression ratio is variably adjustable. In order to adjust the compression ratio for example systems with variable connecting rod length are known.

DE 10 2005 055 199 A1 discloses a connecting rod in which a pivot able lever is used it the small connecting rod eye wherein an eccentrical element is inserted in a central opening of the pivot able lever. The eccentrical element is used for receiving a wrist pin. The lever forms a shaft-hub connection with the eccentrical element. Since the connection is highly loaded during operations of the connecting rod the requirements with respect to fabrication tolerances of the joining partners are high. The actuation pistons supported at the upper connecting rod eye are supported by a ball bearing in ball head receivers and bolted down by a transversal bolt at this location.

### BRIEF SUMMARY OF THE INVENTION

Thus, it is an object of the invention to provide a ball bearing with high bad bearing capability and including a ball head supported in a ball head receiver, wherein the ball bearing assembles easily, has a high load bearing capability and facilitates fabrication tolerances.

It is another object of the invention to provide a connecting rod with the ball bearing.

The objects are achieved by the features of the independent claims.

Advantageous embodiments and advantages of the invention can be derived from the dependent claims, the description and the drawing figure.

A ball bearing is proposed that includes a ball head that is arranged at a support rod, wherein the ball bearing is supported in a ball head receiver of an exterior component, wherein the ball head is secured at its external surface in the ball head receiver by at least one radially inward protruding safety element against sliding from the ball head receiver.

In particular the safety element can be formed by a wall portion of the external element, e.g. by a radially inward protruding embossing. Advantageously the ball head is pivotable in the ball head receiver in all directions in space and simultaneously only pullable from the ball head receiver in axial direction with a high pull out force.

According to an advantageous embodiment of the invention the ball head receiver can include a cambered base element which is adjoined in the axial direction by a cylindrical space and the at least one recess can be arranged at a transition between a cambered portion and a cylindrical portion or in the cylindrical portion. The cambered base element is advantageously adapted in its contact portion to the outer contour of the ball head so that the ball head is easily pivot able. By the same token the cambered base element provides a defined end position of the ball head in the axial direction. Advantageously the cambered portion is approximately as deep as the radius of the ball head. The cylindrical space provides room for the safety element and has a greater diameter than the ball head.

According to an advantageous embodiment of the invention the ball head receiver can include at least one recess at its outer wall wherein a base of the recess forms the safety element at least in portions. Advantageously the base can be gently pressed inward after inserting the ball head so that the base contacts the outer surface of the ball head gently.

According to an advantageous embodiment of the invention the base of the recess can form an undercut at least in portions. Thus, the base can be closed or include pass through openings in some portions.

According to an advantageous embodiment of the invention the recess can be a bore hole with an at least partially provided bore hole base. The bore hole base forms a thin bar which is pressed inward slightly and which can be deformed accordingly.

According to an advantageous embodiment of the invention two or more bore holes can be arranged at the circumference of the external component. Thus, a force that is imparted upon the ball head through the safety elements is applied more uniformly.

According to an advantageously embodiment of the invention the recess can be configured as a ring groove at an outer wall of the external element. A base of the ring groove can be deformed after inserting the ball head and can contact the ball head all around. Thus, it is also conceivable to press the base of the groove inward only at individual locations.

According to an advantageous embodiment of the invention the safety element can be formed by a camber of the closed base of the recess.

According to another advantageous embodiment of the invention a connecting rod with at least one ball bearing is proposed that includes at least one ball head that is arranged at a support rod, wherein the ball head is supported in a ball head receiver, and wherein the ball head is secured at its outer surface in the ball head receiver by a safety element of the ball head receiver against sliding out of the ball head receiver. The ball bearing can be produced economically, assembles easily and provides a high level of safety against unintentional puffing of the ball head from the ball head receiver.

### BRIEF DESCRIPTION OF THE DRAWINGS

Further advantages of the invention can be derived from the subsequent drawing description. The drawing figures illustrate embodiments of the invention. The drawing figures, the description and the patent claims include numerous features in combination. A person skilled in the art will advantageously also view the features individually and combine them into useful other combinations, wherein:

FIG. 1 illustrates a connecting rod with two ball bearings that is known in the art; and

FIG. 2 illustrates an embodiment of a ball bearing according to an embodiment of the invention.

### DETAILED DESCRIPTION OF THE INVENTION

In the drawing figures identical or like components are configured with identical reference numerals. The figures only illustrate embodiments and do not limit the spirit can scope of the invention.

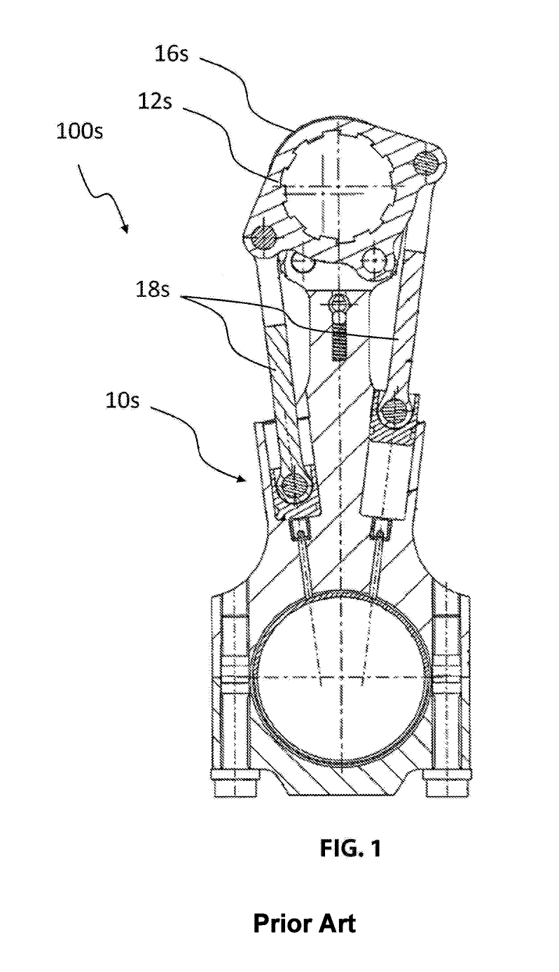

The known connecting rod 100s in FIG. 1 includes an upper connecting rod eye 12s which is provided to receive a non illustrated wrist pin. The wrist pin is pressed in a known manner into a piston of the internal combustion engine. The upper connecting rod bearing eye 12s is separated by a connecting rod from the large connecting rod bearing eye that is at the bottom in the drawing figure.

The upper connecting rod bearing eye 12s is pivotable about a pivot axis by a bearing element that is configured as an eccentrical element wherein the pivot axis is arranged offset parallel to the upper connecting rod bearing eye. Thus, the eccentrical element is inserted into an opening of the lever 16s. Thus, it is possible to change the upper connecting rod bearing eye with respect to its distance from a connecting rod bearing eye axis of the lower connecting rod bearing eye in the figure and to implement a variable compression in the combustion chamber of a combustion engine through actuation pistons 18s supported at the upper connecting rod bearing eye 12s. Thus, the actuation pistons 18s are supported by a ball bearing 10s in receivers and bolted down therein with transversal bolts. The actuation pistons 18 are loaded by a hydraulic pressure that is provided in hydraulic chambers that cooperate with the actuation pistons 18s.

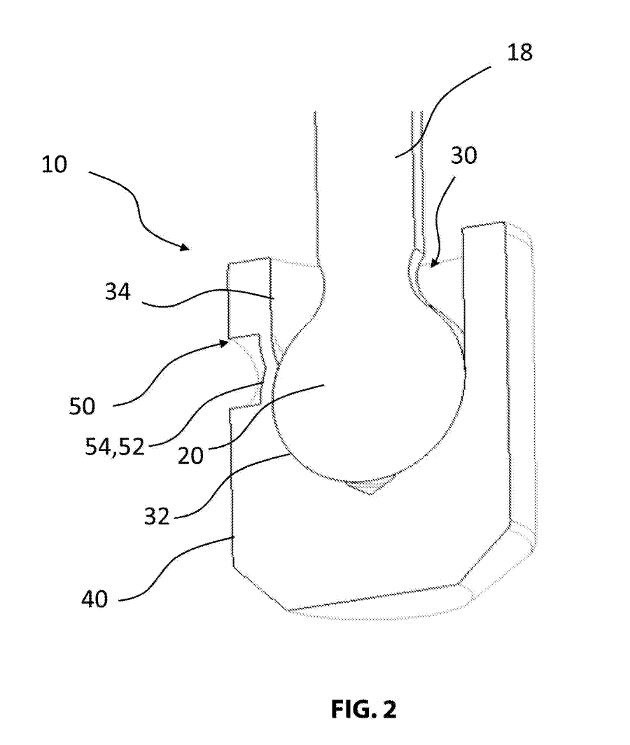

FIG. 2 illustrates a first embodiment of a ball bearing 10 according to an embodiment of the invention. The ball bearing 10 includes a ball head 20 arranged at a support rod 18 wherein the ball head is supported in a ball head receiver 30 of an exterior component 40. The ball head 20 is secured at its outer surface in the ball head receiver 30 by a safety element 54 against sliding or pulling out of the ball head receiver 30.

In the illustrated embodiment the safety element 54 is formed by an embossing which forms an undercut. The safety element 54 is part of the base 52 of a radially inward protruding recess 50 in the outer wall of the outer component 40.

The ball head receiver 30 includes a cambered base element 32 which is adapted to the outer contour of the ball head 20 and on which the ball head 20 can slide in order to facilitate a pivoting of the support rod 18. In the axial direction towards the open end of the ball head receiver 30 a cylindrical space 34 adjoins in which the recess 50 is arranged. The recess is advantageously arranged at a transition between the cambered and cylindrical space 34. Then the ball head 20 can be enclosed substantially without clearance between the cambered component 32 and the safety element 54 without requiring substantial deformation of the base 52.

A single bore hole is illustrated in the figure and configured as a recess 50. Plural recesses 50 which are arranged at a circumference of the outer element 40 create a thin wall thickness (bar) in bases 52 of the recesses. The bar is pressed inward against the rod by the ball head and plastically deformed with a tool provided for this purpose. Instead of bore holes also a circumferential ring groove or interrupted groove segments can be provided. The support rod 18 with the ball head 20 can only be dismounted with a rather high force.

The ball bearing 10 is advantageously used for supporting the support rod 18 of a connecting rod 100 which is advantageously used in a combustion engine with adjustable compression ratio, wherein the connecting rod 100 can include devices for adjusting the effective connecting rod length as described supra. Also under a high load the ball head 20 of the ball bearing 10 is safely supported in the ball head receiver 30.

What is claimed is:

1. A ball bearing, comprising:
a ball head that is arranged at a support rod,
wherein the ball head is supported in a ball head receiver of an exterior component, and
wherein the ball head is secured at its outer surface by at least one radially inward protruding safety element of the ball head receiver against sliding out of the ball head receiver.

2. The ball bearing according to claim 1,
wherein the exterior component includes at least one recess at an outer wall, and
wherein a base of the at least one recess forms a safety element at least in portions.

3. The ball bearing according to claim 1,
wherein the ball head receiver includes a cambered space which is adjoined in an axial direction by a cylindrical space, and
wherein the at least one recess is arranged at a transition between the cambered space and the cylindrical space or in the cylindrical space.

4. The ball bearing according to claim 2, wherein the at least one radially inward protruding safety element is formed in that the base of the recess forms an undercut at least in a portion of the base.

5. The ball bearing according to claim 1, wherein the recess is a bore hole with a bore hole base.

6. The ball bearing according to claim 1, wherein two or more bore holes are arranged at a circumference of the exterior component.

7. The ball bearing according to claim 1, wherein the recess is provided as a ring groove in the outer wall of the exterior component.

8. The ball bearing according to claim 2,
wherein the safety element is formed by a camber of the base of the recess, and
wherein the base of the recess is closed.

9. A connecting rod, comprising: at least one ball bearing according to claim 1.

10. The connecting rod according to claim 9, wherein the connecting rod includes devices for adjusting an effective connecting rod length.

11. An internal combustion engine with adjustable compression ratio, comprising: at least one connecting rod according to claim 10.
